(19) United States
(12) Patent Application Publication
(10) Pub. No.: US 2013/0255376 A1
(43) Pub. Date: Oct. 3, 2013

(54) INERTIAL SENSOR AND MEASURING METHOD FOR MEASURING ANGULAR VELOCITY USING THE SAME

(71) Applicants: Seung Heon Han, Gyunggi-do (KR); Jung Eun Noh, Gyunggi-do (KR); Yu Heon Yi, Gyunggi-do (KR); Jong Woon Kim, Gyunggi-do (KR); Byoung Won Hwang, Gyunggi-do (KR); Kyung Rin Kim, Gyunggi-do (KR); Chang Hyun Kim, Gyunggi-do (KR)

(72) Inventors: Seung Heon Han, Gyunggi-do (KR); Jung Eun Noh, Gyunggi-do (KR); Yu Heon Yi, Gyunggi-do (KR); Jong Woon Kim, Gyunggi-do (KR); Byoung Won Hwang, Gyunggi-do (KR); Kyung Rin Kim, Gyunggi-do (KR); Chang Hyun Kim, Gyunggi-do (KR)

(73) Assignee: SAMSUNG ELECTRO-MECHANICS CO., LTD., Gyunggi-do (KR)

(21) Appl. No.: 13/532,604

(22) Filed: Jun. 25, 2012

(30) Foreign Application Priority Data
Mar. 28, 2012 (KR) 1020120031938

(51) Int. Cl. G01C 19/56

(52) U.S. Cl. 73/504.12

(57) ABSTRACT

Disclosed herein is an inertial sensor. The inertial sensor according to a preferred embodiment of the present invention includes: a plate-shaped membrane; a mass body provided under the membrane; posts provided under an outside edge of the membrane and surrounding the mass body; a piezoelectric body formed on the membrane; sensing electrodes formed on the piezoelectric body; driving electrodes formed on an outer circumference of the sensing electrodes, wherein tri-axis angular velocity can be measured without time division by a driving control unit continuously applying first driving voltage and second driving voltage that are is AC driving voltage having a phase difference of 90°.

### CROSS REFERENCE TO RELATED APPLICATION

This application claims the benefit of Korean Patent Application No. 10-2012-0031938, filed on Mar. 28, 2012, entitled “Inertial Sensor and Measuring Method for Angular Velocity Using the Same,” which is hereby incorporated by reference in its entirety into this application.

### BACKGROUND OF THE INVENTION

1. Technical Field

The present invention relates to an inertial sensor and a method for measuring angular velocity using the same.

2. Description of the Related Art

Recently, an inertial sensor has been used as various applications, for example, military such as an artificial satellite, a missile, an unmanned aircraft, or the like, vehicles such as an air bag, electronic stability control (ESC), a black box for a vehicle, or the like, hand shaking prevention of a camcorder, motion sensing of a mobile phone or a game machine, navigation, or the like.

The inertial sensor generally adopts a configuration in which a mass body is adhered to an elastic substrate such as a membrane, or the like, in order to measure acceleration and angular velocity. Through the configuration, the inertial sensor may calculate the acceleration by measuring inertial force applied to the mass body and may calculate the angular velocity by measuring Coriolis force applied to the mass body.

A process of measuring the acceleration and the angular velocity by using the inertial sensor will be described in detail below. First, the acceleration may be calculated by Newton's law of motion “F=ma”, where “F” represents inertial force applied to the mass body, “m” represents a mass of the mass body, and “a” is acceleration to be measured. Among others, the acceleration a may be obtained by sensing the inertial force F applied to the mass body and dividing the sensed inertial force F by the mass m of the mass body that is a predetermined value. Further, the angular velocity may be calculated by Coriolis force “F=2 mΩ×v”, where “F” represents the Coriolis force applied to the mass body, “m” represents the mass of the mass body, “Ω” represents the angular velocity to be measured, and “v” represents the motion velocity of the mass body. Among others, since the motion velocity V of the mass body and the mass m of the mass body are values known in advance, the angular velocity Ω may be calculated by sensing the Coriolis force F applied to the mass body.

In or measure tri-axis angular velocity according to the prior art, when one mass is used, time division is used or two mass is used as described in JP Laid-Open Patent No. 2010-11729. In particular, in the case of measuring the tri-axis angular velocity using the time division, crosstalk may occur in a period in which an axis is converted by repeating X-axis driving->stop->Y-axis driving->stop. In addition, in order to prevent the crosstalk, a driving time difference between two axes is sufficiently wide. However, in this case, the degradation in sampling rate of the sensor may occur.

### SUMMARY OF THE INVENTION

The present invention has been made in an effort to provide an inertial sensor capable of measuring tri-axis angular velocity using one mass body by simultaneously performing driving of an X-axis and a Y-axis with a phase difference from each other so as to measure tri-axis angular velocity and a method for measuring angular velocity using the same.

According to a preferred embodiment of the present invention, there is provided an inertial sensor, including: a plate-shaped membrane; a mass body provided under the membrane; posts provided under an outside edge of the membrane and surrounding the mass body; a piezoelectric body formed on the membrane; sensing electrodes formed on the piezoelectric body; driving electrodes formed on an outer circumference of the sensing electrodes while being spaced apart from each other; and a driving control unit applying first driving voltage for vibrating the mass body in an X-axis direction and applying second driving voltage for vibrating the mass body in a y-axis direction, wherein the first driving voltage and the second driving voltage are AC driving voltage simultaneously applied to the driving electrodes so as to have a phase difference of 90°.

The first driving voltage may be the AC driving voltage having a sine wave type and the second driving voltage may be AC driving voltage having a cosine wave type.

The first driving voltage and the second driving voltage may be continuously applied to the driving electrodes without time division by the driving control unit.

The mass body may be formed in a single mass body.

The sensing electrodes may be provided so as to be closer from a center of the piezoelectric body than the driving electrodes.

The sensing electrodes may be farther away from a center of the piezoelectric body than the driving electrodes.

The sensing electrodes may be formed in an arc shape on the membrane and the driving electrodes may be formed in the corresponding arc shape on an outer circumference of the sensing electrodes.

According to another preferred embodiment of the present invention, there is provided a method for measuring angular velocity, including: simultaneously applying first driving voltage that is AC driving voltage and second driving voltage having a phase difference of 90° from the first driving voltage to driving electrodes by a driving control unit; applying the first driving voltage to an X-axis driving unit and applying the second driving voltage to a Y-axis driving unit; sensing, by a mechanical sensor unit, vibrations of a mass body in X-axis and Y-axis directions by the X-axis driving unit and the Y-axis driving unit; sensing the vibration in the X-axis direction sensed by the mechanical sensor unit to allow a first sensor unit to sense Y-axis or Z-axis angular velocity, and sensing the vibration in the Y-axis direction by the mechanical sensor unit to allow a second sensor unit to sense the X-axis or Z-axis angular velocity; and extracting the Y-axis and Z-axis angular velocities by the first sensor unit by demodulating the signals sensed by the first sensor unit and the second sensor unit and outputting angular velocity signals of each axis by an output unit by extracting the X-axis and Z-axis angular velocities by the second sensor unit.

The first driving voltage may be the AC driving voltage having a sine wave type and the second driving voltage may be AC driving voltage having a cosine wave type.

The mechanical sensor unit may sense a maximum value of the vibration in the X-axis direction or a maximum value of the vibration in the Y-axis direction by calculating a sum of a magnitude and direction of physical force of the vibration by the X-axis driving unit and the vibration by the Y-axis driving unit.

The first driving voltage and the second driving voltage may be continuously applied to the driving electrodes without time division.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view of an inertial sensor according to the preferred embodiment of the present invention;

FIG. 2 is a plan view of the inertial sensor of FIG. 1;

FIG. 3 is a cross-sectional view showing a process of generating a displacement of a membrane of the inertial sensor of FIG. 1;

FIGS. 4A and 4B are graphs showing a phase difference of driving voltage applied to a driving electrode according to a preferred embodiment of the present invention and a displacement of each axis;

FIG. 5 is a plan view showing a vibration direction of the driving electrode according to the angular velocity measurement of the inertial sensor according to the preferred embodiment of the present invention as a flowing direction of time; and

FIG. 6 is a flow chart of a method for measuring angular velocity using the inertial sensor according to the preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the prior art would obscure the gist of the present invention, the description thereof will be omitted.

Hereinafter, preferred embodiments of the present invention are described in detail with reference to the accompanying drawings.

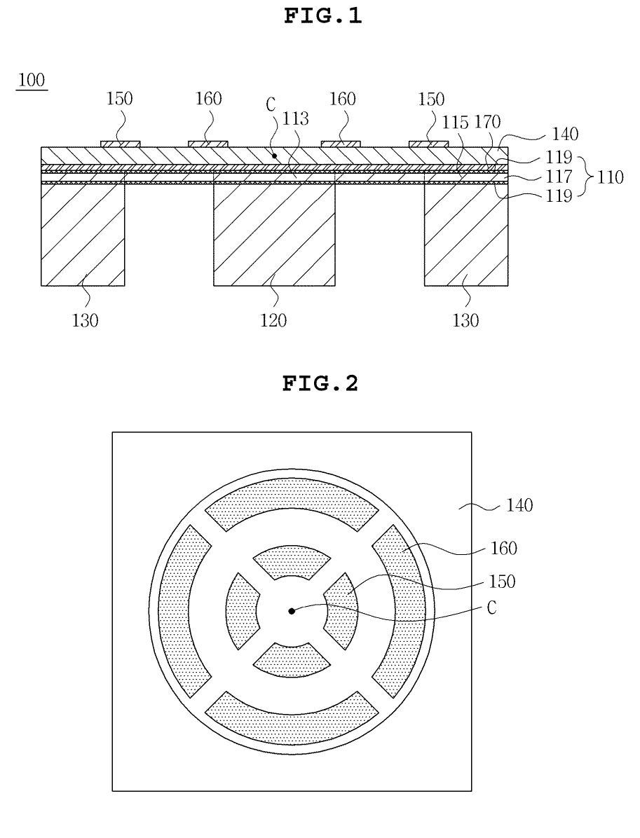

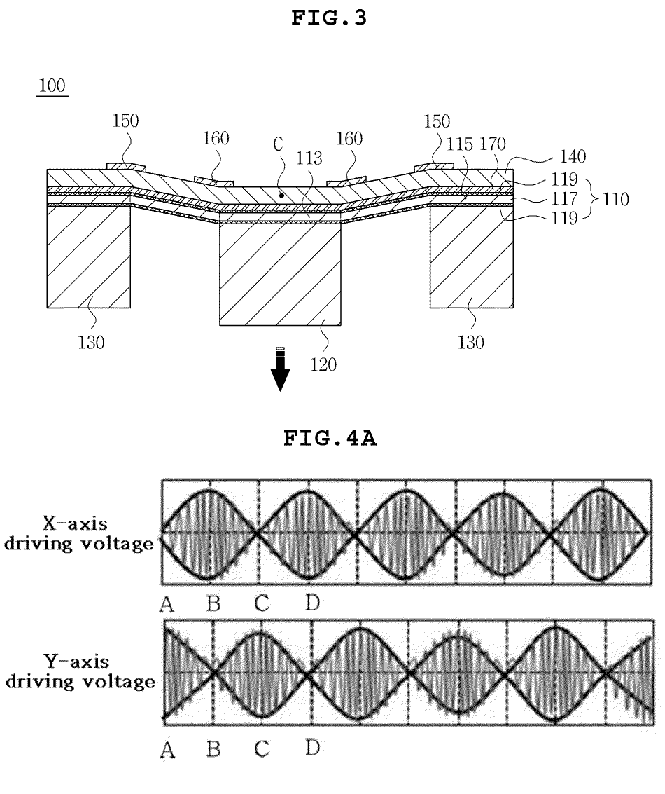

FIG. 1 is a cross-sectional view of an inertial sensor according to the preferred embodiment of the present invention, FIG. 2 is a cross-sectional view showing a process of generating a displacement of a membrane of the inertial sensor of FIG. 1, and FIG. 3 is a plan view of the inertial sensor of FIG. 1.

An inertial sensor 100 according to a preferred embodiment of the present invention includes a plate-shaped membrane 110, a mass body 120 provided under the membrane 110, posts 130 provided under an outside edge of the membrane 110 and surrounding the mass body 120, a piezoelectric body 140 formed on the membrane 110, sensing electrodes 150 formed on the piezoelectric body 140, driving electrodes 160 formed on an outer circumference of the sensing electrodes 150 while being spaced apart from each other, and a driving control unit (not shown) applying first driving voltage for vibrating the mass body in an X-axis direction and applying second driving voltage for vibrating the mass body in a y-axis direction, wherein the first driving voltage and the second driving voltage are the AC driving voltage simultaneously applied to the driving electrodes 160 so as to have a phase difference of 90°.

In particular, the inertial sensor 100 according to the preferred embodiment of the present invention simultaneously applies the first driving voltage and the second driving voltage having the phase difference of 90° as AC voltage by the driving control unit (not shown) applying voltage to the driving electrodes 160, thereby measuring tri-axis acceleration without time division. Hereinafter, a description of the inertial sensor 100 and a method for measuring angular velocity using the inertial sensor 100 according to a preferred embodiment of the present invention will be described below.

The membrane 110 is formed in a plate shape and has elasticity so as to vibrate the mass body 120. Here, a boundary of the membrane 110 is not accurately partitioned but may be partitioned into a central portion 113 of the membrane 110 and an edge 115 provided along the outside of the membrane 110. In this case, the bottom portion of the central portion 113 of the membrane 110 is provided with the mass body 120, such that the central portion 113 of the membrane 100 is displaced in response to the motion of the mass body 120. In addition, the bottom portion of the edge 115 of the membrane 110 is provided with the posts 130 to serve to support the central portion 113 of the membrane 110. Meanwhile, a material of the membrane 110 is not particularly limited, but may adopt a silicon substrate 117 having oxide films 119 formed on both sides thereof.

The mass body 120 may be displaced by inertial force or Coriolis force and is provided under an outside edge of the membrane 110. In particular, as shown in FIG. 1, the mass body is preferably provided under the central portion of the membrane 110. In addition, the posts 130 are formed in a hollow shape to support the membrane 110 so as to serve to secure a space in which the mass body 120 may be displaced. The posts 130 are disposed under the edge 115 of the membrane 110. In this configuration, the mass body 120 may be formed in, for example, a cylindrical shape and the posts 140 may be formed in a square pillar shape in which a squared cavity is formed at a center thereof. That is, when being viewed from a transverse section, the mass body 120 is formed in an arc shape and the posts 140 is formed in a square shape having a squared opening provided at the center thereof. However, the shape of the above-mentioned mass body 120 and the posts 130 is only an example but is not necessarily limited thereto. Therefore, the mass body 120 and the posts 130 may be formed in all the shapes known to those skilled in the art. Meanwhile, the above-mentioned membrane 110, the mass body 120, and the posts 130 may be formed by selectively etching a silicon substrate 117 such as a silicon on insulator (SOI) substrate, or the like.

The membrane 110 may be provided with a piezoelectric body 140 to drive the mass body 120 or sense the displacement of the mass body 120. Here, the piezoelectric body 140 may be made of lead zirconate titanate (PZT), barium titanate (BaTiO₃), lead titanate (PbTiO₃), lithium niobate (LiNbO₃), silicon dioxide (SiO₂), or the like. More specifically, when voltage is applied to the piezoelectric body 140, an inverse piezoelectric effect of expanding and contracting the piezoelectric body 140 is generated. The mass body 120 provided under the membrane 110 may be driven by using the inverse piezoelectric effect. On the other hand, when stress is applied to the piezoelectric body 140, a piezoelectric effect of generating a potential difference is generated. The displacement of the mass body 120 provided under the membrane 110 can be sensed by using the piezoelectric effect. In addition, in order to use the inverse piezoelectric effect and the piezoelectric effect of the piezoelectric body 140 for each region, a plurality of piezoelectric bodies 140 may be patterned. For example, the piezoelectric bodies 140 may be patterned at each position corresponding to the sensing electrodes 150 and the driving electrodes 160 as shown in FIG. 2.

The sensing electrodes 150 generate voltage according to the displacement of the membrane 110, such that the control unit (not shown) serves to sense the displacement of the membrane 110. As shown in FIG. 3, when the membrane 110 is displaced, the electrical polarization is generated in the piezoelectric body 140 and as a result, voltage is generated in the sensing electrodes 150. Therefore, the control unit may measure the displacement of the membrane 110 based on the voltage generated in the sensing electrodes 150.

The driving electrodes 160 apply voltage to the piezoelectric body 140 such that the piezoelectric body 140 may serve to vibrate the membrane 110. In detail, when voltage is applied to the driving electrodes 160, electric energy is applied to the piezoelectric body 140 to generate the driving force, thereby vibrating the membrane 110. In particular, the preferred embodiment of the present invention simultaneously applies the first driving voltage and the second driving voltage to the driving electrode 160 through the driving control unit. The first driving voltage and the second driving voltage may preferably use the AC driving voltage that is AC voltage having the phase difference of 90°. The detailed description thereof will be provided below.

A common electrode 170 is disposed at a surface opposite to the piezoelectric body 140 to correspond to the sensing electrodes 150 and the driving electrodes 160. As shown in FIG. 1, the common electrode 170 may be disposed over one surface of the piezoelectric body 140 but may be patterned to correspond to the sensing electrodes 150 and the driving electrodes 160. The common electrode 170 is included in the sensing electrodes 150 or the driving electrodes 160 and is formed to generate the potential difference. Therefore, the common electrode 170 may perform the substantially same action as the sensing electrodes 150 or the driving electrodes 160.

Meanwhile, the sensing electrodes 150 and the driving electrodes 160 may be preferably provided at the corresponding portion between the central portion 113 and edge 115 of the membrane 110 due to the elastic deformation between the central portion 113 and the edge 115 of the membrane 110. However, the driving electrodes 150 and the sensing electrodes 160 are not necessarily be disposed at the corresponding portion between the central portion 113 and the edge 115 of the membrane 110, but as shown in FIG. 3, a part thereof may be disposed at the corresponding portion between the central portion 113 or the edge 115 of the membrane 110. Herein, a position of the sensing electrode 150 and the driving electrode 160 may be changed from each other based on a center C of the piezoelectric body 140. That is, the sensing electrodes 150 may be provided so as to be closer from the center C of the piezoelectric body 140 than the driving electrodes 160 (see FIG. 2) and the sensing electrodes 150 may be farther away from the center C of the piezoelectric body 140 than the driving electrodes 160.

The driving control unit (not shown) simultaneously applies the first driving voltage for vibrating the mass body 120 in the X-axis direction and the second driving voltage for vibrating the mass body 120 in the Y-axis direction to the driving electrodes 160. The first driving voltage and the second driving voltage may be preferably applied to have the phase difference of 90° as the AC driving voltage. Here, the first driving voltage becomes the AC driving voltage having a sine wave type and the second driving voltage is the AC driving voltage having a cosine wave, such that the AC voltage having the phase difference of 90° may be applied. Even though the first driving voltage and the second driving voltage for vibration in the X-axis direction and the Y-axis direction are simultaneously applied, when the vibration in the X-axis direction is maximal by each phase difference, the vibration in the Y-axis direction substantially approaches zero, and as a result, the same effect as applying the voltage for each axis driving and applying the driving voltage for another axis driving through time division can be substantially obtained. However, the preferred embodiment of the present invention measures the tri-axis angular velocity through the X-axis and Y-axis vibrations without the time division to prevent the occurrence of crosstalk that may occur between the axis conversion periods. In addition, the first driving voltage and the second driving voltage continuously apply the X-axis and Y-axis vibration signals through the phase difference and the signal and the motion of the X-axis and the Y-axis are synchronized, thereby making it possible to simplify the signal processing. In addition, it is possible to increase the sampling rate due to the synchronization between the signal and the motion. In addition, the tri-axis angular velocity can be measured without the time division even though the single mass body 120 by simultaneously applying the driving voltage according to the X-axis driving the Y-axis driving. The detailed contents of the method for measuring angular velocity will be described below.

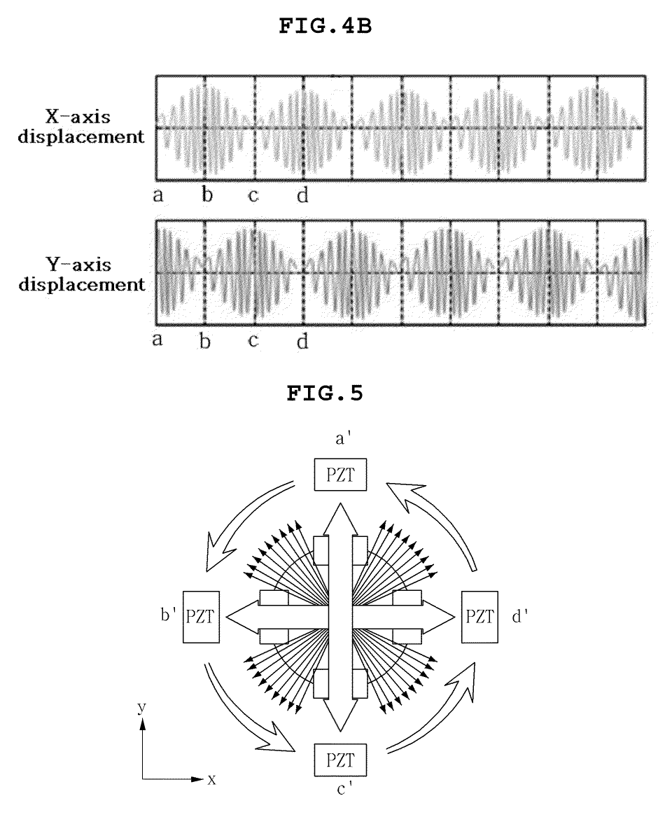

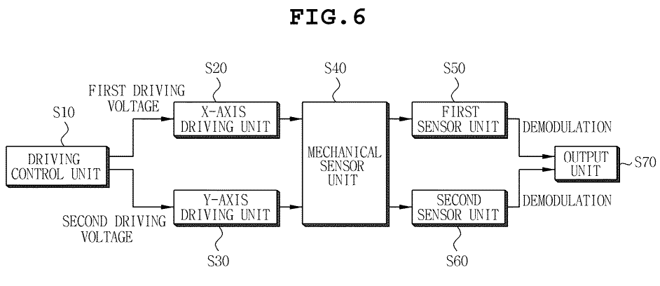

FIGS. 4A and 4B are graphs showing a phase difference of driving voltage applied to a driving electrode according to a preferred embodiment of the present invention and a displacement of each axis and FIG. 5 is a plan view showing a vibration direction of the driving electrode according to the angular velocity measurement of the inertial sensor according to the preferred embodiment of the present invention as a flowing direction of time.

As shown in FIG. 4A, the preferred embodiment of the present invention simultaneously applies the first driving voltage that is the X-axis driving voltage and the second driving voltage that is the Y-axis driving voltage as the AC voltage having the phase difference of 90° by the driving control unit. The first driving voltage becomes zero at a first point A at which the first driving voltage and the second driving voltage of FIG. 4A are applied and the second driving voltage having the phase difference of 90° applies the maximum voltage. That is, in FIG. 4B, an X-axis displacement becomes zero at point a corresponding to the point A and the Y-axis displacement represents a maximum displacement at point a. Therefore, the Y-axis driving is maximal and the X-axis driving substantially approaches zero, thereby making it possible to the X axis or Y axis angular velocity from the vibration according to the pure Y-axis driving.

Next, when moving to point B of FIG. 4A, the first driving voltage according to the X-axis driving is applied as maximally as possible and the second driving voltage according to the Y-axis driving is applied as minimally as possible. Similarly, the X-axis displacement of the corresponding FIG. 4B becomes a maximum value at point b and the Y-axis displacement substantially approaches zero at the point b. In this case, the Y-axis or the Z-axis angular velocity can be calculated by sensing the vibration according to the pure X-axis driving.

The first driving voltage and the second driving voltage are applied to have the phase difference of 90°, such that the maximum displacement of the X axis or the Y axis of a, b, c, and d of FIG. 4B are alternately shown from each point of A, B, C, and D of FIG. 4A, thereby making it possible to measure the vibrations of each axis without the time division.

FIG. 5 graphically shows the vibration motion of the mass body 120 when the first driving voltage and the second driving voltage are applied by the driving control unit. In the vibrations among points A, B, C, and D of FIG. 4A, the X-axis vibration and the Y-axis vibration coexist. Therefore, the mass body 120 moves according a sum of vectors according to the magnitude and direction of each vibration and therefore, as shown in FIG. 5, the mass body 120 continuously performs a circular movement. The Y-axis displacement is maximally vibrated at point a of FIG. 4B as in point a′ of FIG. 5 and the Y-axis displacement is reduced and the X-axis displacement is increased, toward point b of FIG. 4B and then, the X-axis displacement is maximal at point b and the X-axis displacement is vibrated as maximally as possible as in point ‘b’ of FIG. 5. It is possible to stably measure the tri-axis angular velocity without generating the crosstalk according to the time division by continuously repeating the process. Consequently, the mass body performs the rotating motion as shown in FIG. 5 by continuously applying the first driving voltage and the second driving voltage.

FIG. 6 is a flow chart of a method for measuring angular velocity using the inertial sensor according to the preferred embodiment of the present invention.

The method for measuring angular velocity according to the preferred embodiment of the present invention may include: simultaneously applying the first driving voltage that is the AC driving voltage and the second driving voltage having the phase difference of 90° from the first driving voltage to the driving electrodes 160 by the driving control unit (S10); applying the first driving voltage to the X-axis driving unit (S20) and applying the second driving voltage to the Y-axis driving unit (S30); sensing, by the mechanical sensor unit, the vibrations of the mass body 120 in the X-axis and Y-axis directions by the X-axis driving unit and the Y-axis driving unit (S40); sensing the vibration in the X-axis direction sensed by the mechanical sensor unit to allow the first sensor unit to sense the Y-axis or Z-axis angular velocity (S50); sensing the vibration in the Y-axis direction to allow the second sensor unit to sense the X-axis or Z-axis angular velocity (S60); and extracting the Y-axis and Z-axis angular velocities by the first sensor unit by demodulating the signals sensed by the first sensor unit and the second sensor unit and outputting, by an output unit, the angular velocity signals of each axis by extracting the X-axis and Z-axis angular velocities by the second sensor unit (S70).

First, the simultaneously applying of the first driving voltage that is the AC driving voltage and the second driving voltage having the phase difference of 90° from the first driving voltage to the driving electrode 160 by the driving control unit (S10) is performed. Here, as described above with reference to the first driving voltage and the second driving voltage, as the AC driving voltage, the first driving voltage may be the AC driving voltage having the sine wave type and the second driving voltage may be the AC driving voltage having the cosine wave type. The first driving voltage and the second driving voltage are continuously applied to the driving electrodes 160 without the time division.

Next, the applying of the first driving voltage to the X-axis driving unit (S20) and the applying of the second driving voltage to the Y-axis driving unit (S30) are performed. When the first driving voltage and the second driving voltage are applied to the X-axis driving unit and the Y-axis driving unit, the vibrations of the mass body 120 in the X-axis and Y-axis directions by the X-axis driving unit and the Y-axis driving unit are sensed by the mechanical sensor unit (S40). When the mass body 120 is displaced, as described above, the electrical polarization is generated according to the displacement of the membrane 110 and as a result, the voltage is generated in the sensing electrodes 150. As a result, the first sensor unit and the second unit may sense the tri-axis angular velocity signal as described below. The mechanical sensor unit senses the maximum value of the vibration in the X-axis direction or the maximum value of the vibration in the Y-axis direction by calculating a sum of the magnitude and direction of physical force of the vibration by the X-axis driving unit and the vibration by the Y-axis driving unit, thereby making it possible to calculate the tri-axis angular velocity by the first sensor unit and the second sensor unit.

Next, the sensing of the first sensor unit senses the Y-axis or Z-axis angular velocities by sensing the vibration in the X-axis direction sensed by the mechanical sensor unit (S50) and the sensing of the X-axis or Z-axis angular velocity by sensing the vibration in the Y-axis direction by the second sensor unit (S60) are performed. As can be appreciated from the graphs of FIGS. 4A and 4B, as the first driving voltage and the second driving voltage are applied as the AC driving voltage having the phase difference of 90° from each other, when the Y-axis displacement is maximal (point a of the Y-axis displacement graph), the X-axis displacement substantially approaches zero (point a of the Y-axis displacement graph), such that the X-axis and Z-axis angular velocities can be calculated according to the vibration and displacement of the Y axis without the time division. Similarly, when the X-axis displacement is maximal (point b of the graph of the X-axis displacement), the Y-axis displacement substantially approach zero (point b of the Y-axis displacement graph) and therefore, the pure Y-axis is driven without the time division, thereby making it possible to calculate the X-axis and Z-axis angular velocity.

Next, the extracting of the Y-axis and Z-axis angular velocities by the first sensor unit by demodulating the signal sensed by the first sensor unit and the second sensor unit and the outputting of the angular velocity signals of each axis by the output unit by extracting the X-axis and Z-axis angular velocities by the second sensor unit (S70) are performed. When the tri-axis angular velocity is obtained from the first sensor unit and the second sensor unit, the obtained tri-axis angular velocity is analyzed three-dimensionally and thus, the final angular velocity is integrated, which is output through the output unit. During this process, when the tri-axis angular velocity sensed by the first sensor unit and the second sensor unit is extracted, the angular velocities of each axis may be extracted by the demodulation. The demodulation generally extracts the signal from the modulated high frequency. Herein, the angular velocities of each axis calculated by the first sensor unit and the second sensor unit are each extracted and the process of the demodulation is performed during the process of integrating the extracted angular velocities.

Herein, the method for measuring angular velocity according to the preferred embodiment of the present invention is described. In particular, continuously applying without the time division by the first driving unit and the second driving unit overlaps the contents described in the inertial sensor according to the preferred embodiment of the present invention as described above and therefore, the detailed description thereof will be omitted. The detailed description of each process of measuring the angular velocity overlaps the configuration and operation description of the inertial sensor according to the preferred embodiment of the present invention and therefore, will be omitted herein.

According to the preferred embodiments of the present invention, it is possible to prevent the crosstalk occurring during the time division for measuring the angular velocity.

Further, it is possible to increase the reliability of angular velocity measurement of the inertial sensor while simplifying the signal processing by simultaneously applying the driving voltage of the X-axis and the Y-axis of the forwarding sine wave and cosine wave.

In addition, it is possible to increase the sampling rate due to the driving voltage of the two axes simultaneously applied and the synchronization between the mass bodies moving according to the driving voltage.

Moreover, it is possible to secure the reliability of tri-axis angular velocity measurement while stably and continuously vibrating the mass body by applying the AC driving voltage for driving the two axes having the phase difference of 90°.

Also, it is possible to improve the productivity of the module including the inertial sensor without simplifying the structure by measuring the smooth tri-axis angular velocity even using the single mass body without time division.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An inertial sensor, comprising:
a plate-shaped membrane;
a mass body provided under the membrane;
posts provided under an outside edge of the membrane and surrounding the mass body;
a piezoelectric body formed on the membrane;
sensing electrodes formed on the piezoelectric body;
driving electrodes formed on an outer circumference of the sensing electrodes while being spaced apart from each other; and
a driving control unit applying first driving voltage for vibrating the mass body in an X-axis direction and applying second driving voltage for vibrating the mass body in a y-axis direction,
wherein the first driving voltage and the second driving voltage are AC driving voltage simultaneously applied to the driving electrodes so as to have a phase difference of 90°.

2. The inertial sensor as set forth in claim 1, wherein the first driving voltage is the AC driving voltage having a sine wave type and the second driving voltage is AC driving voltage having a cosine wave type.

3. The inertial sensor as set forth in claim 1, wherein the first driving voltage and the second driving voltage are continuously applied to the driving electrodes without time division by the driving control unit.

4. The inertial sensor as set forth in claim 1, wherein the mass body is formed in a single mass body.

5. The inertial sensor as set forth in claim 1, wherein the sensing electrodes are provided so as to be closer from a center of the piezoelectric body than the driving electrodes.

6. The inertial sensor as set forth in claim 1, wherein the sensing electrodes are farther away from a center of the piezoelectric body than the driving electrodes.

7. The inertial sensor as set forth in claim 1, wherein the sensing electrodes are formed in an arc shape on the membrane and the driving electrodes are formed in the corresponding arc shape on an outer circumference of the sensing electrodes.

8. A method for measuring angular velocity, comprising:
simultaneously applying first driving voltage that is AC driving voltage and second driving voltage having a phase difference of 90° from the first driving voltage to driving electrodes by a driving control unit;
applying the first driving voltage to an X-axis driving unit and applying the second driving voltage to a Y-axis driving unit;
sensing, by a mechanical sensor unit, vibrations of a mass body in X-axis and Y-axis directions by the X-axis driving unit and the Y-axis driving unit;
sensing the vibration in the X-axis direction sensed by the mechanical sensor unit to allow a first sensor unit to sense Y-axis or Z-axis angular velocity, and sensing the vibration in the Y-axis direction by the mechanical sensor unit to allow a second sensor unit to sense the X-axis or Z-axis angular velocity; and
extracting the Y-axis and Z-axis angular velocities by the first sensor unit by demodulating the signals sensed by the first sensor unit and the second sensor unit and outputting angular velocity signals of each axis by an output unit by extracting the X-axis and Z-axis angular velocities by the second sensor unit.

9. The method as set forth in claim 8, wherein the first driving voltage is the AC driving voltage having a sine wave type and the second driving voltage is AC driving voltage having a cosine wave type.

10. The method as set forth in claim 8, wherein the mechanical sensor unit senses a maximum value of the vibration in the X-axis direction or a maximum value of the vibration in the Y-axis direction by calculating a sum of a magnitude and direction of physical force of the vibration by the X-axis driving unit and the vibration by the Y-axis driving unit.

11. The method as set forth in claim 8, wherein the first driving voltage and the second driving voltage are continuously applied to the driving electrodes without time division.
